(19) United States
(12) Patent Application Publication
(10) Pub. No.: US 2006/0227848 A1
(43) Pub. Date: Oct. 12, 2006

(54) Acupuncture needle thermocouple clip

(76) Inventor: Tien Huang, Arcadia, CA (US)

Correspondence Address: LAW OFFICES OF CLEMENT CHENG, 17220 NEWHOPE STREET #127, FOUNTAIN VALLEY, CA, 92708, US

(21) Appl. No.: 11/026,961

(22) Filed: Dec. 30, 2004

(51) Int. Cl. G01K 7/00

(52) U.S. Cl. 374/179

(57) ABSTRACT

An acupuncture needle temperature monitoring device has a clip having a pair of grasping ends. A pair of thermocouple metal members is mounted at opposing ends of the clip. The metal contact members contact an acupuncture needle when the pair of grasping ends is closed to grasp an acupuncture needle. The clip and pair of grasping ends are shaped to grasp an acupuncture needle, whereby the acupuncture needle forms a thermocouple junction. An electrical conductor electrically conducts the pair of thermocouple metal members to a signal processor that provides a temperature reading of an acupuncture needle when an acupuncture needle is retained in the clip.

### DISCUSSION OF RELATED ART

Commonly, an infrared heat lamp can apply thermal radiation to a skin surface while acupuncture needles are applied to skin. The heat from the thermal radiation is easily measured because of the uniform temperature of the skin, and needles when an infrared heat lamp is used. When an infrared lamp is not used, the acupuncture needles are heated either by traditional moxabustion or by modern means such as electrical resistance heating. Localized heating presents difficult acupuncture needle temperature monitoring problems.

Measuring the temperature of acupuncture needles is difficult because the portion of the acupuncture needle entering the skin is small. Also, it is oftentimes desirable to measure the temperature of acupuncture needles while the acupuncture needles are in use.

Thermo couple switching is useful for monitoring temperature. A novel use of a thermocouple is shown in U.S. Pat. No. 4,821,285 describing the use of a thermocouple switch to monitor temperature of ore cars moving on rails.

### BRIEF DESCRIPTION OF THE DRAWINGS

FIG. 1 is a side view of the clip.

FIG. 2 is a side exploded view of the clip.

FIG. 3 is a perspective view of the clip.

FIG. 4 is a perspective view of the clip holding an acupuncture needle and including the lead.

FIG. 5 shows a perspective view of the entire device including the clip, the lead, and the plug.

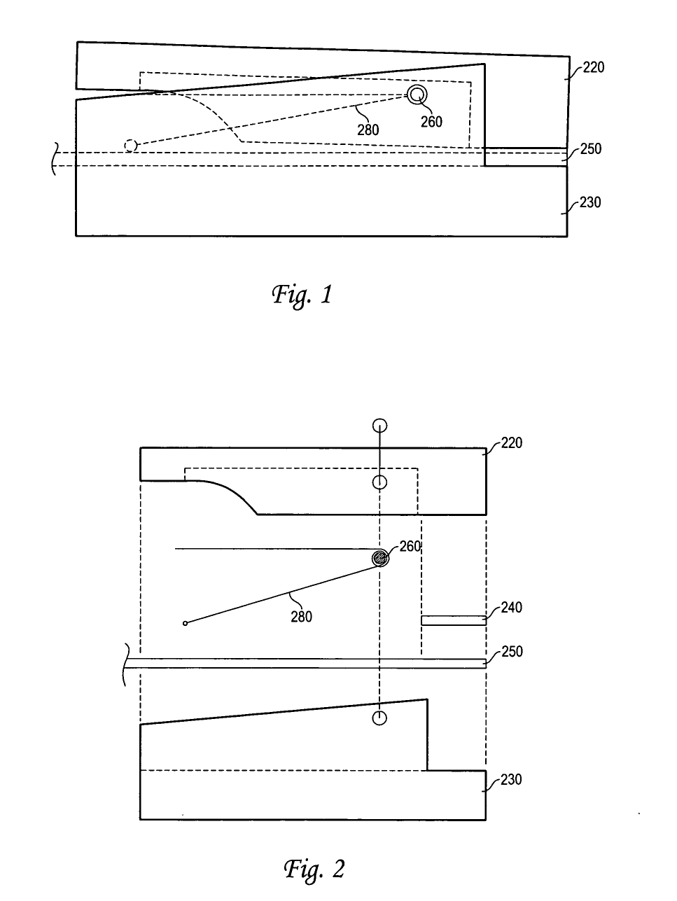

### DETAILED DESCRIPTION OF THE PREFERRED EMBODIMENT

The present device is used to monitor the temperature of an acupuncture needle, when the acupuncture needle is inserted into skin for treatment of a patient. The device includes a clip as shown in figure one. The clip has an upper member 220 and a lower member 230 mounted on a rotating axis 260. A spring member 280 formed as a coil spring is shown in figure one where the coil is retained by the axis 260 which is a pin formed as a small round rod that joins the upper and lower member and the spring. The spring force is enough to retain an acupuncture needle.

The clip has wire mounted within. The electrical wire 250 carries signals from the thermocouple formed in the clip to a data logger thermometer or other such data analyzer for signal processing.

FIG. 2 shows and exploded view of the device. The top member 220 preferably has a hollow section that nests with the lower member 230 and the axis pin 260 retains the members. The thermocouple has a pair of metal members 240 contacting an acupuncture needle when the clip attaches to an acupuncture needle. The clip can be manually opened to receive an acupuncture needle, and is biased closed by the spring.

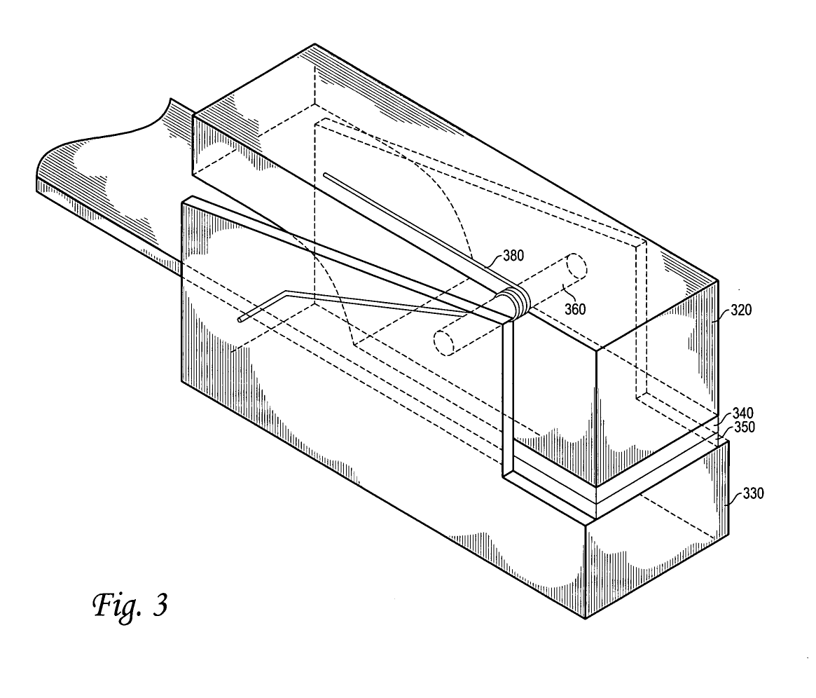

FIG. 3 shows a perspective view of a clip held in closed position by spring 380. The perspective view shows the nesting of the upper and lower members so that the upper 320 and lower member 330 move only along the rotational axis 360.

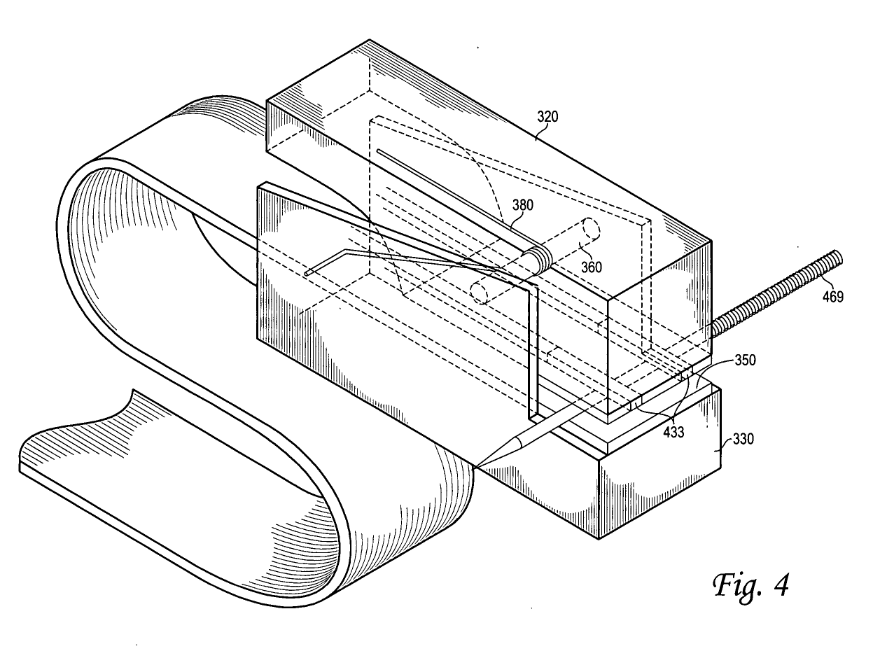

FIG. 4 shows the thermocouple clip having a pair of metal members 433 contacting the acupuncture needle 469 when the acupuncture needle 469 is held so the metal members 433 make electrical connection to the acupuncture needle. The acupuncture needle can be made of a variety of metals including stainless steel, gold, and silver. The acupuncture needle forms the thermocouple junction of the thermocouple sensor and becomes a part of the sensor. The metal members 433 are electrically connected to the wiring 450 that is in an electrical circuit with a data logger thermometer that calculates a temperature. The temperature is based upon electrical characteristics of the electrical circuit formed by the wiring 450, and the metal contact members 433. The other parts of the clip as seen in FIG. 4 include spring 480, rotational axis 460 and the upper 420 and lower member 430. The perspective view shows the nesting configuration of the upper 420 and lower member 430 to limit motion in the direction parallel to the rotational axis 460.

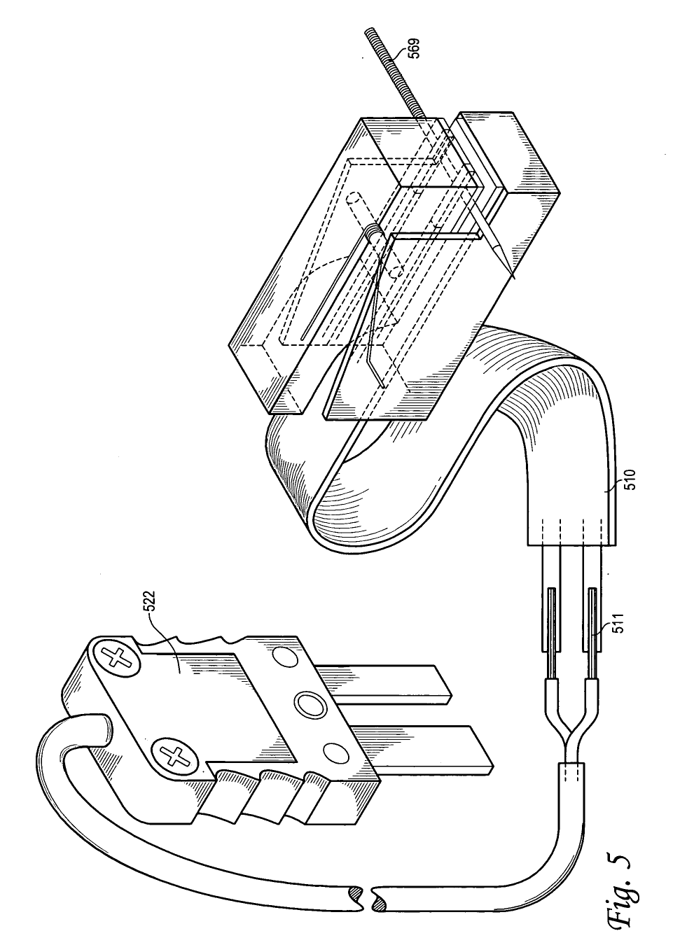

As seen in FIG. 5, the needle 569 can be held at a 90 degrees angle to the clip and the wiring 510 is initially a thin ribbon and can be joined an junction 511. The junction joins the thin ribbon wire with larger gauge wiring that continues to a plug 522 that plugs into an electrical device such as a data logger thermometer. The data logger thermometer is commonly available in the marketplace. The plug 522 is preferably of standard dimensions and specifications so that ordinary data logger thermometers may be used with the device.

1. An acupuncture needle temperature monitoring device comprising:
a. a clip having a pair of grasping ends;
b. a pair of thermocouple metal members mounted at opposing ends of the clip when the metal contact members contact an acupuncture needle when the pair of grasping ends are closed to grasp an acupuncture needle;
c. wherein the clip and a pair of grasping ends are shaped to grasp an acupuncture needle, whereby the acupuncture needle forms a thermocouple junction;
d. an electrical conductor electrically conducting the pair of thermocouple metal members to a signal processor that provides a temperature reading of an acupuncture needle when an acupuncture needle is retained in the clip.

2. The acupuncture needle temperature monitoring device of claim 1, wherein the clip is formed of an upper member pivotally mounted to a lower number, the upper member forming an upper grasping end, and the lower member forming a lower grasping end.

3. The acupuncture needle monitoring device of claim 2, wherein the clip is formed of a plastic.

4. The acupuncture needle monitoring device of claim 2, wherein both metal contact members are formed on the upper member, whereby the acupuncture needle forms thermocouple junction when the pair of grasping ends close to hold the acupuncture needle.

5. The acupuncture needle claim 1, wherein an upper grasping end formed on the pair of grasping ends has mounted on them the thermocouple metal members.

6. The acupuncture needle of claim 1, wherein the thermocouple metal members are melted on an upper grasping end formed on the pair of grasping ends.

7. An acupuncture needle monitoring device comprising:
a. a clip of hiring a pair of grasping ends,
b. a thermocouple mounted on at least one of the pairs of the grasping ends, the thermocouple having a soldered injunction thoroughly exposed to at least one grasping end, wherein the grasping ends are shaped to retain an acupuncture needle.

8. The device of claim 7, wherein the clip is made of a pair of pivotal mounted members, wherein the bias means is a metal spring.

9. An acupuncture needle monitoring device comprising:
a. a clip having a pair of grasping ends, shaped to grasp and acupuncture needle,
b. a thermocouple metal contact pair made of two metal contact members, the metal contact members embedded on the grasping ends positioned to contact and acupuncture needle with the acupuncture needle is held in the clip.

10. The device of claim 9, wherein the metal content members are mounted on the same grasping end.

11. The device of claim 9, wherein the metal contact members are mounted on opposing grasping ends, where in the grasping hands are pivoting connected.

12. The acupuncture needle monitoring device of claim 9, further comprising an acupuncture needle held in the clip.

13. The acupuncture needle monitoring device of claim 12, wherein the acupuncture needle held in the clip is made of silver.

14. The acupuncture needle monitoring device of claim 12, wherein the acupuncture needle held in the clip is made of gold.

15. The acupuncture needle monitoring device of claim 12, wherein the acupuncture needle held in the clip is made of stainless steel.
